(19) United States
(12) Patent Application Publication
(10) Pub. No.: US 2021/0356780 A1
(43) Pub. Date: Nov. 18, 2021

(54) DISPLAY PANEL AND DISPLAY DEVICE

(71) Applicant: WUHAN CHINA STAR OPTOELECTRONICS TECHNOLOGY CO., LTD., Wuhan (CN)

(72) Inventor: Xing XIONG, Wuhan (CN)

(73) Assignee: WUHAN CHINA STAR OPTOELECTRONICS TECHNOLOGY CO., LTD., Wuhan (CN)

(21) Appl. No.: 16/613,124

(22) PCT Filed: Sep. 23, 2019
(86) PCT No.: PCT/CN2019/107335

§ 371 Date: Nov. 13, 2019

(30) Foreign Application Priority Data
Jul. 3, 2019 (CN) 201910601328.1

(51) Int. Cl. G02F 1/1339; G02F 1/1337; G02F 1/1335

(52) U.S. Cl. CPC G02F 1/1339; G02F 1/133512; G02F 1/133723

(57) ABSTRACT

The present invention provides a display panel and a display device, the display panel includes a first substrate including a center area and an edge area around the center area, a first functional layer disposed on the center area, a seal disposed on the first functional layer and extending along an edge of the first functional layer to the edge area, a second functional layer disposed on the seal, and a second substrate disposed on the second functional layer.

### FIELD OF INVENTION

The disclosure relates to the display technology field, and more particularly, to a display panel and a display device.

### BACKGROUND OF INVENTION

Due to advantages of liquid crystal displays (LCD), such as low radiation, low energy consumption, good color performance, and ease of portability. LCDs are widely used in the display field, playing a very important role in planarization-panel TVs, personal computers, mobile display panels, car displays and other products.

In actual manufacturing process, display panels need to undergo single-drop reliability test. However, since the drop test usually results in a liquid crystal leak, it cannot satisfy the requirement of the reliability test.

### SUMMARY OF INVENTION

The technical problem mainly solved by the present disclosure is how to prevent the occurrence of liquid crystal leakage during the reliability test, thereby improving the effectiveness of the test.

To achieve the above the technical problem, in the first aspect, the present disclosure provides a display panel comprises a first substrate comprising a center area and an edge area around the center area, a first functional layer disposed on the center area, a seal disposed on the first functional layer and extending along an edge of the first functional layer to the edge area, a second functional layer disposed on the seal, and a second substrate disposed on the second functional layer.

Wherein, the first functional layer comprises a first shielding layer, a first planarization layer, and a first alignment layer disposed in sequence on the first substrate, and the seal disposed on the first alignment layer and covering a portion of the first planarization layer and extending along an edge of the first planarization layer to the edge area. The second functional layer comprises a second alignment layer and an insulation layer disposed in sequence on the seal, and the seal covering the second alignment layer and the insulation layer.

In the display panel provided by the present disclosure, an orthographic projection of the first alignment layer on the second substrate and an orthographic projection of the second alignment layer on the second substrate are overlapping.

In the display panel provided by the present disclosure, the display panel further comprises a buffer layer disposed between the first substrate and the seal. The buffer layer is disposed on the edge area and is disposed around the first functional area, a first interval is disposed between the buffer layer and the first functional layer, and the seal extends along the first interval to the edge area.

In the display panel provided by the present disclosure, the buffer layer comprises a second shielding layer and a second planarization layer disposed in sequence on the first substrate. The second shielding layer and the first shielding layer are disposed on a same layer, and the second planarization layer and the first planarization layer are disposed on a same layer.

In the display panel provided by the present disclosure, the insulation layer comprises a first sub-insulation layer correspondingly disposed on the center area and a second sub-insulation layer correspondingly disposed on the edge area. A second interval is disposed between the first sub-insulation layer and the second sub-insulation layer, and the seal extends along the second interval to the second substrate.

In the display panel provided by the present disclosure, the first interval and the second interval are disposed in an offset manner.

In the display panel provided by the present disclosure, the first interval and the second interval are disposed oppositely.

In the display panel provided by the present disclosure, a material of the first alignment layer is polyimide.

In the display panel provided by the present disclosure, a material of the second alignment layer is polyimide.

In the second aspect, the present disclosure provides a display panel comprising a first substrate. The first substrate comprises a center area and an edge area around the center area, a first functional layer disposed on the center area, a seal disposed on the first functional layer and extending along an edge of the first functional layer to the edge area, a second functional layer disposed on the seal, and a second substrate disposed on the second functional layer.

In the display panel provided by the present disclosure, the first functional layer comprises a first shielding layer, a first planarization layer, and a first alignment layer disposed in sequence on the first substrate.

Wherein the seal disposed on the first alignment layer and covering a portion of the first planarization layer, and extending along an edge of the first planarization layer to the edge area.

In the display panel provided by the present disclosure, the second functional layer comprises a second alignment layer and an insulation layer disposed in sequence on the seal.

Wherein, the seal covering the second alignment layer and the insulation layer.

In the display panel provided by the present disclosure, an orthographic projection of the first alignment layer on the second substrate and an orthographic projection of the second alignment layer on the second substrate are overlapping.

In the display panel provided by the present disclosure, the display panel further comprises a buffer layer disposed between the first substrate and the seal.

Wherein, the buffer layer is disposed on the edge area and disposed around the first functional area, a first interval is disposed between the buffer layer and the first functional layer, and the seal extends along the first interval to the edge area.

In the display panel provided by the present disclosure, the buffer layer comprises a second shielding layer and a second planarization layer disposed in sequence on the first substrate.

Wherein, the second shielding layer and the first shielding layer are disposed on a same layer, and the second planarization layer and the first planarization layer are disposed on a same layer.

In the display panel provided by the present disclosure, the insulation layer comprises a first sub-insulation layer correspondingly disposed on the center area and a second sub-insulation layer correspondingly disposed on the edge area.

Wherein, a second interval is disposed between the first sub-insulation layer and the second sub-insulation layer, and the seal extends along the second interval to the second substrate.

In the display panel provided by the present disclosure, the first interval and the second interval are disposed in an offset manner.

In the display panel provided by the present disclosure, the first interval and the second interval are disposed oppositely.

In the third aspect, the present disclosure provides a display device comprising a display panel. The display panel comprises a first substrate comprising a center area and an edge area around the center area, a first functional layer disposed on the center area, a seal disposed on the first functional layer and extending along an edge of the first functional layer to the edge area, a second functional layer disposed on the seal, and a second substrate disposed on the second functional layer.

The advantageous effect of the present disclosure is to prevent the occurrence of liquid crystal leakage during the reliability test, thereby improving the effectiveness of the test

### DESCRIPTION OF DRAWINGS

In order to more clearly illustrate the technical solutions of the embodiments of the present invention, the drawings used in the description of the embodiments will be briefly described as below. Obviously, the drawings described as below are just some embodiments of the present invention. For one of ordinary skill in the art, under the premise of no creative labor, other drawings can also be obtained according to these drawings.

FIG. 1 is a schematic structural diagram of a first embodiment of a display panel provided by the present disclosure.

FIG. 2 is a schematic structural diagram of a second embodiment of a display panel provided by the present disclosure.

FIG. 3 is a schematic structural diagram of a third embodiment of a display panel provided by the present disclosure.

FIG. 4 is a schematic structural diagram of a fourth embodiment of a display panel provided by the present disclosure.

FIG. 5 is a schematic structural diagram of a fifth embodiment of a display panel provided by the present disclosure.

### DETAILED DESCRIPTION OF PREFERRED EMBODIMENTS

The embodiments of the present disclosure are described in detail below, and the examples of the embodiments are illustrated in the drawings, wherein the same or similar reference numerals are used to refer to the same or similar elements or elements having the same or similar functions. The embodiments described below with reference to the drawings are exemplified and are only used to explain the present disclosure, and are not to be construed as limiting the present application.

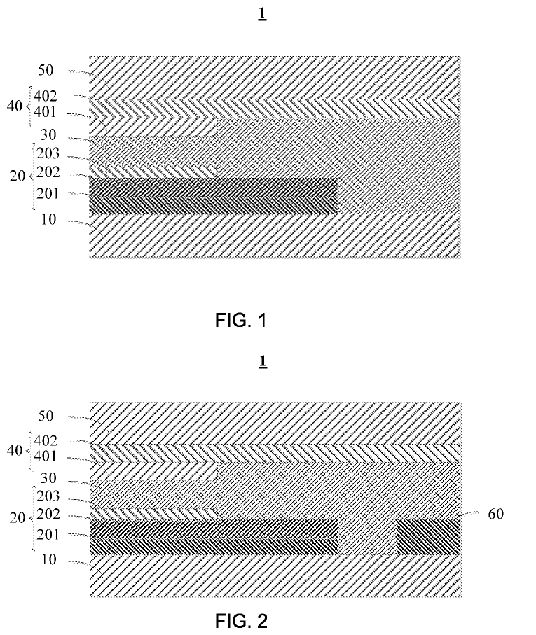

Referring to FIG. 1, FIG. 1 is a schematic structural diagram of a first embodiment of a display panel provided by the present disclosure.

The present disclosure provides a display panel 1, the display panel 1 comprises a first substrate 10, a first functional layer 20, a seal 30, a second functional layer 40, and a second substrate 50. The first substrate 10 comprises a center area 101 and an edge area 102, the edge area 102 disposed around the center area 101, the first functional layer 20 disposed on the center area 101, the seal 30 disposed on the first functional layer 20 and extending along an edge of the first functional layer 20 to the edge area 102, the second functional layer 40 disposed on the seal 30, and the second substrate 50 disposed on the second functional layer 40.

For example, the first substrate 10 may be a color film substrate, the second substrate 50 may be an array substrate, and the first substrate 10 and the second substrate 50 may both be glass substrates. Each functional layer of the color filter substrate may be formed on the first substrate 10, such as shielding layers, alignment layers, and planarization layers, etc. Namely, the functional layer 20 formed on the first substrate 10, each functional layer of the array substrate may be formed on the second substrate 50, such as insulation layers, etc., and the second functional layer 50 formed on the second substrate 50. A material of the seal 30 comprises epoxy, heat curing agent, and photoinitiator. The seal 30 is used to stick the first substrate 10 and the second substrate 50 together to prevent leakage of liquid crystal injected between the first substrate 10 and the second substrate 50, and prevents the outside water vapor and dust and other harmful substances from entering and polluting the liquid crystal.

It should be noted that, a size of the first substrate 10 is greater than a size of the first functional layer 20 in the present disclosure, thus, the seal 30 can extend along the edge of the first functional layer 20 to the edge area 102, thereby increasing the bonding ability between the first substrate 10 and the second substrate 50, which can prevent the occurrence of liquid crystal leakage during the reliability test, thereby improving the effectiveness of the test.

Further, referring to FIG. 1, the first functional layer 20 may comprise a first shielding layer 201, a first planarization layer 202, and a first alignment layer 203 sequentially disposed on the first substrate 10. The seal 30 disposed on the first alignment layer 203 and covers a portion of the first planarization layer 202, and extending along an edge of the first planarization layer 202 to the edge area 102.

The first alignment layer 203 is used to align the liquid crystal of the display panel 1. The first shielding layer 201 mainly is used to prevent color mixture from color resistor of the display panel 1, to increase the color contrast ratio of the display panel 1. In general, the smaller the area of the first shielding layer 201 is, the higher the aperture ratio of the display panel 1. The first planarization layer 202 is used to protect a black shielding layer 202, preventing the liquid crystal of the liquid crystal display panel 1 from contacting the first shielding layer 201. Furthermore, the first planarization layer 202 may also planarize the surface of the first shielding layer 201 toward the liquid crystals, facilitating subsequent alignment of the first alignment layer 203 to the liquid crystals of the display panel 1.

The second functional layer 40 specifically comprises a second alignment layer 401 and an insulation layer 402 disposed in sequence on the seal 30, and the seal 30 covers the second alignment layer 401 and the insulation layer 402.

The insulation layer 402 may comprise an interlayer insulating layer, a gate insulating layer, and a protective layer. The second alignment layer 401 is used to align the liquid crystals in the display panel 1 with the first alignment layer 203.

In some embodiments, a material of the first alignment layer 203 may be polyimide, and a material of the second alignment layer 401 may also be polyimide.

It should be noted that, during the actual manufacturing process, due to process limitation, a portion of the first alignment layer 203 and the second alignment layer 401 flow to the area of the seal 30, as shown in FIG. 1. Thus, in the present disclosure, the seal 30 covers a portion of the first alignment layer 203 and the second alignment layer 401.

In some embodiments, an orthographic projection of the first alignment layer 203 on the second substrate 50 and an orthographic projection of the second alignment layer 401 on the second substrate 50 are overlapping.

Referring to FIG. 2, FIG. 2 is a schematic structural diagram of a second embodiment of a display panel provided by the present disclosure. The present disclosure further provides a display panel 1, the display panel 1 of FIG. 2 differs from the display panel 1 of FIG. 1 in that the display panel 1 of FIG. 2 further comprises a buffer layer 60 disposed between the first substrate 10 and the seal 30.

The buffer layer 60 is disposed on the edge area 102, and the buffer layer 60 is disposed around the first functional layer 20. A first interval 701 is disposed between the buffer layer 60 and the first functional layer 20, and the seal 30 extends along the first interval 701 to the edge area 102.

In the embodiment of the present disclosure, by adding the buffer layer 60 to the edge area 102 of the first substrate 10, this will not only prevent the occurrence of liquid crystal leakage during the reliability test, the buffer layer 60 can also be used to buffer impact force caused by a drop during the drop test, thereby improving the reliability of the test.

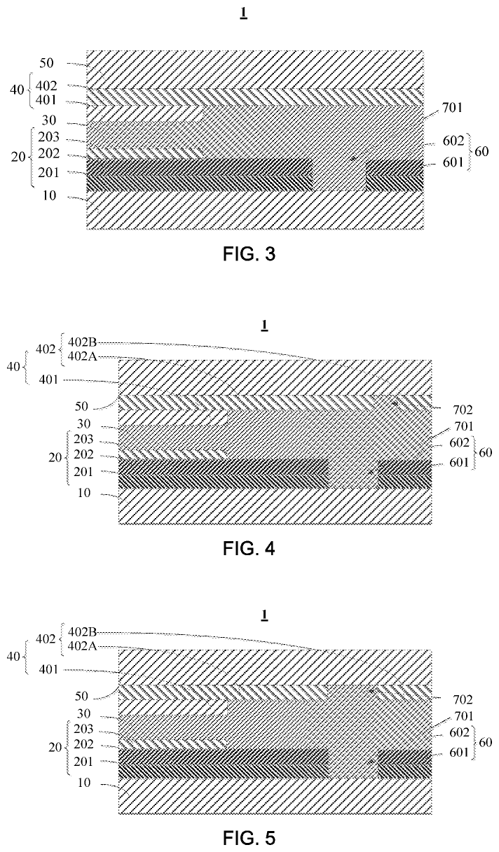

Referring to FIG. 3, FIG. 3 is a schematic structural diagram of a third embodiment of a display panel provided by the present disclosure. The present disclosure further provides a display panel 1, the display panel 1 of FIG. 3 differs from the display panel 1 of FIG. 1 in that, the buffer layer 60 comprises a second shielding layer 601 and a second planarization layer 602 disposed in sequence on the first substrate 10. The second shielding layer 601 and the first shielding layer 201 are disposed on the same layer, and the second planarization layer 602 and the first planarization layer 601 are disposed on the same layer.

The function of the second planarization layer 602 is similar to that of the first planarization layer 203. The function of the second light-shielding layer 601 is similar to that of the first light-shielding layer 201. For details, please refer to the previous embodiment, and details are not described herein.

Referring to FIG. 4, FIG. 4 is a schematic structural diagram of a fourth embodiment of a display panel provided by the present disclosure. The present disclosure further provides a display panel 1, the display panel 1 of FIG. 4 differs from the display panel 1 of FIG. 1 in that, the insulation layer 402 comprises a first sub-insulation layer 402A correspondingly disposed on the center area 101 and a second sub-insulation layer 402B correspondingly disposed on the edge area 102. A second interval 702 is disposed between the first sub-insulation layer 402A and the second sub-insulation layer 4026, and the seal 30 extends along the second interval 702 to the second substrate 50.

In some embodiments, the first interval 701 and the second interval 702 are disposed in an offset manner, as shown as FIG. 4.

In some embodiments, the first interval 701 and the second interval 702 are disposed oppositely, as shown as FIG. 5.

In the embodiment of the present disclosure, the seal 30 extends along the second interval 702 to the second substrate 50, which increases the contact area of the sealant 30 and the second substrate 50, thus, further increasing the bonding ability between the first substrate 10 and the second substrate 50, which can prevent the occurrence of liquid crystal leakage during the reliability test, thereby improving the effectiveness of the test.

The present disclosure further provides a display device comprising the display panel 1 of any embodiment in the present embodiment. For details, please refer to the previous embodiment, and details are not described herein.

The display panel and the display device provided by the embodiments of the present application are described in detail above. Herein, specific examples are used in this article to explain the principles and specific embodiments of the present invention. The description of the aforesaid embodiments is only used to help understand the present invention and the core idea thereof. At the same time, for one of ordinary skill in the art, according to the idea of the present disclosure, there will be changes in the specific embodiments and the scope of application. In summary, the content of this specification should not be construed as limiting the application.

1. A display panel, comprising:
a first substrate comprising a center area and an edge area around the center area;
a first functional layer disposed on the center area;
a seal disposed on the first functional layer and extending along an edge of the first functional layer to the edge area;
a second functional layer disposed on the seal; a second substrate disposed on the second functional layer;
wherein, the first functional layer comprising a first shielding layer, a first flat layer, and a first alignment layer in sequence disposed on the first substrate;
the seal disposed on the first alignment layer and covering a portion of the first flat layer, and extending along an edge of the first flat layer to the edge area;
the second functional layer comprising a second alignment layer and an insulation layer in sequence disposed on the seal; and
the seal covering the second alignment layer and the insulation layer.

2. The display panel as claimed in claim 1, wherein an orthographic projection of the first alignment layer on the second substrate and an orthographic projection of the second alignment layer on the second substrate are overlapping.

3. The display panel as claimed in claim 2, wherein the display panel comprising a buffer layer disposed between the first substrate and the seal; and
the buffer layer disposed on the edge area and disposed around the first functional area, and a first interval disposed between the buffer layer and the first functional layer, and the seal extending along the first interval to the edge area.

4. The display panel as claimed in claim 3, wherein the buffer layer comprising a second shielding layer and a second flat layer in sequence disposed on the first substrate; and the second shielding layer and the first shielding layer are disposed on the same layer, and the second flat layer and the first flat layer are disposed on the same layer.

5. The display panel as claimed in claim 3, wherein the insulation layer comprising a first sub-insulation layer corresponding disposed on the center area and a second sub-insulation layer corresponding disposed on the edge area; and a second interval disposed between the first sub-insulation layer and the second sub-insulation layer, and the seal extending along the second interval to the second substrate.

6. The display panel as claimed in claim 5, wherein the first interval and the second interval are disposed crossing.

7. The display panel as claimed in claim 5, wherein the first interval and the second interval are disposed oppositely.

8. The display panel as claimed in claim 1, wherein material of the first alignment layer is polyimide.

9. The display panel as claimed in claim 1, wherein material of the second alignment layer is polyimide.

10. A display panel, comprising:
a first substrate comprising a center area and an edge area around the center area; a first functional layer disposed on the center area; a seal disposed on the first functional layer and extending along an edge of the first functional layer to the edge area; a second functional layer disposed on the seal; and a second substrate disposed on the second functional layer.

11. The display panel as claimed in claim 10, the first functional layer comprising a first shielding layer, a first flat layer, and a first alignment layer in sequence disposed on the first substrate; the seal disposed on the first alignment layer and covering a portion of the first flat layer, and extending along an edge of the first flat layer to the edge area.

12. The display panel as claimed in claim 11, the second functional layer comprising a second alignment layer and an insulation layer in sequence disposed on the seal; and the seal covering the second alignment layer and the insulation layer.

13. The display panel as claimed in claim 12, wherein an orthographic projection of the first alignment layer on the second substrate and an orthographic projection of the second alignment layer on the second substrate are overlapping.

14. The display panel as claimed in claim 12, wherein the display panel comprising a buffer layer disposed between the first substrate and the seal; and
the buffer layer disposed on the edge area and disposed around the first functional area, and a first interval disposed between the buffer layer and the first functional layer, and the seal extending along the first interval to the edge area.

15. The display panel as claimed in claim 14, wherein the buffer layer comprising a second shielding layer and a second flat layer in sequence disposed on the first substrate; and the second shielding layer and the first shielding layer are disposed on the same layer, and the second flat layer and the first flat layer are disposed on the same layer.

16. The display panel as claimed in claim 14, wherein the insulation layer comprising a first sub-insulation layer corresponding disposed on the center area and a second sub-insulation layer corresponding disposed on the edge area; and a second interval disposed between the first sub-insulation layer and the second sub-insulation layer, and the seal extending along the second interval to the second substrate.

17. The display panel as claimed in claim 16, wherein the first interval and the second interval are disposed crossing.

18. The display panel as claimed in claim 16, wherein the first interval and the second interval are disposed oppositely.

19. A display device, comprising a display panel; the display panel comprising: a first substrate comprising a center area and an edge area around the center area; a first functional layer disposed on the center area; a seal disposed on the first functional layer and extending along an edge of the first functional layer to the edge area; a second functional layer disposed on the seal; and a second substrate disposed on the second functional layer
